(19) United States
(12) Patent Application Publication
(10) Pub. No.: US 2002/0035632 A1
(43) Pub. Date: Mar. 21, 2002

(54) System and method of providing event information

(75) Inventor: Hidehiro Matsumoto, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/955,805

(22) Filed: Sep. 19, 2001

(30) Foreign Application Priority Data
Sep. 20, 2000 (JP) 284462

(51) Int. Cl. G06F 15/16; G06F 11/30; G06F 12/14; H04L 9/32

(52) U.S. Cl. 709/229; 709/218; 713/200

(57) ABSTRACT

The Internet is utilized to provide advertisements and information to particular users who are interested in a product or service. Means is provided for finding such users. As a result of participating in an event held in a particular time period and a particular region, an event participant receives the right to access a privileged Website, this privileged access right being issued by the Website manager who has organized the event. An event participant who has received a privileged access right can, by accessing a privileged Website, browse information on the privileged Website as well. When an event participant acquires a privileged access right, he can also receive a reward such as a discount linked to a product, and the Website manager can, in exchange for an advertising fee, provide an advertiser with user information along with information relating to accesses made to the privileged Website.

### BACKGROUND OF THE INVENTION

1. Field of the Invention

The present invention relates to a system and method of providing information relating to an event. It relates in particular to a system and method of providing event information wherein a service information provider registers service information in advance with an information provision means such as a portal site for service information, and obtains user information relating to particular users who make use of said service information. The service information provider does this by utilizing the fact that a particular user who is interested in service information that is the registered content will access the aforementioned service information provision means.

2. Description of Related Art

Because the Internet can provide users directly with advertisements and various types of information relating to products and services, information providers such as advertising agencies and value-added carriers that utilize the Internet as a medium for advertising and information are increasing in number. There are also increasing numbers of communication terminals, including personal computers, mobile communication terminals and personal digital assistants, that can connect to the Internet via radio channels.

In other words, more and more Websites utilize networks such as the Internet to supply users directly and relatively inexpensively with advertisements and information. However, in response to pressure from their clients, i.e., the companies who commission the advertisements, information providers such as value-added carriers and advertising agencies are looking for ways of reaching users more effectively with advertisements for the products and services that their clients want to sell.

Hitherto, however, most advertising and publicity on the Internet has been aimed at a large number of unspecified users. As a result, not only have information resources been used inefficiently, but users have had the inconvenience of receiving unwanted e-mail and information.

### SUMMARY OF THE INVENTION

The present invention is intended overcome the aforementioned shortcomings of the prior art. It is an object of the invention to provide an event information provision system, and a method thereof, that utilizes an information communication medium such as the Internet to provide advertisements and information to those users who are interested in a product or service, and that has means for finding such users.

An event information provision method according to this invention comprises: a step wherein a user participates in an event organized by an event manager; a “privileged access right acquisition” step wherein the aforementioned user, by participating in this event, acquires a pre-established privileged access right; a “privileged Website information provision” step wherein, in response to access by the aforementioned user who has exercised this privileged access right, said user is supplied with information exclusive to the privileged Website, said information being provided by the aforementioned event manager; and a step of registering information relating to the aforementioned user.

An event information provision method according to this invention also comprises: a step of providing advertisement information for an event, said advertisement information being provided by an advertiser; and a step of providing the aforementioned advertiser with information relating to the aforementioned user, in exchange for an advertising fee in respect of this advertisement. An event information provision method according to this invention also comprises, in the aforementioned privileged access right acquisition step, setting a condition that the aforementioned user has to satisfy in order to acquire the privileged access right, this condition having some degree of difficulty, and granting the privileged access right to the aforementioned user if the user satisfies this condition.

An event information provision method according to this invention also comprises, in the aforementioned privileged Website information provision step, checking, in response to access by the aforementioned user, whether or not that user has obtained the privileged access right, and providing the privileged Website information only if the user has obtained the right. An event information provision method according to this invention is also adapted so that the aforementioned event manager and the aforementioned user are connected via a network, and so that information relating to the aforementioned event and information relating to the privileged Website are registered at a portal site.

An event information provision system according to this invention comprises: privileged access right granting means for granting a preestablished privileged access right to a user who participates in an event organized by an event manager; privileged Website information provision means which, in response to access by the aforementioned user who has exercised this privileged access right, supplies that user with information exclusive to the privileged Website, said information being provided by the aforementioned event manager; and registration means for registering information relating to the aforementioned user.

An event information provision system according to this invention also comprises means for providing the aforementioned advertiser with information relating to the aforementioned user, in exchange for an advertising fee in respect of an advertisement for the aforementioned event, said advertisement having been provided by the advertiser. An event information provision system according to this invention is also adapted so that the aforementioned privileged access right granting means sets a condition that has to be satisfied in order to acquire the privileged access right, this condition having some degree of difficulty, and grants the privileged access right to the aforementioned user if that user satisfies this condition. An event information provision system according to this invention is also adapted so that the aforementioned privileged Website information provision means checks, in response to access by the aforementioned user, whether or not that user has obtained the privileged access right, and provides the privileged Website information only if the user has obtained the right.

The working of this invention will now be described. As a result of participating in an event held in a particular time period and a particular region, a user receives a privileged access right, this being issued by the Website manager who has organized the event. By accessing a portal site (which is an information provision means provided by a portal site manager), an event participant who has received this privileged access right can browse, in addition to information and Websites accessible by an ordinary visitor to that portal site, information on an exclusive Website (hereinafter, such Websites will be termed “privileged Websites”). Furthermore, when the event participant acquires a privileged access right, he can also receive a reward such as a discount linked to a product. In other words, an event participant who has accessed a privileged Website receives privileges.

Meanwhile, at the stage of a user receiving a privileged access right, the Website manager stores, in a database, a registration number for the participant and information relating to the privileged access right that is to be granted, and at the same time registers information relating to the user (hereinafter, such information will be termed “user information”) in a separate database. The former database is utilized for controlling access to the privileged Website, and the latter database is made available, in exchange for an advertising fee, and along with information relating to accesses made to the privileged Website, to the advertiser that is providing advertisements and the like to the Website manager.

Holding an event enables the Website manager to acquire user information relating to event participants and to increase the number of times a site is accessed. Increasing the number of accesses means that the Website manager achieves greater publicity, via advertisements and the like. Moreover, by publishing, on a portal site, information relating to the holding of an event, the Website manager can achieve an increase in the number of secondary event participants. The advertiser can purchase market survey data such as what sort of customer group have displayed an interest during what time period in a particular product, and on this basis can create more effective advertising and publicity.

Furthermore, because a privileged access right is the principal means whereby a Website manager controls access to a privileged Website, the Website manager can regulate that access so as to achieve results that match the requirements of the advertiser, by for example adjusting the time period over which the privileged access right is valid, the number of times it can be issued, and the degree of difficulty involved in acquiring the privileged access right. Because information relating to participants is disclosed only to advertisers who have entered into a contract with the Website manager, inadvertent leaking of information is avoided. Advertising effectiveness can be increased by making event information and advertisements available on the portal site to ordinary users who have not participated in the event.

### BRIEF DESCRIPTION OF THE DRAWINGS

Specific embodiments of the present invention will now be described, by way of example only, with reference to the accompanying of drawings in which:

FIG. 1 summarizes the configuration of an embodiment of the system of the present invention and aids an understanding of how this system works;

FIG. 2 shows a portion of the detailed working of this embodiment of the invention;

FIG. 3 shows a portion of the detailed working of this embodiment of the invention; and

FIG. 4A to FIG. 4D give examples of browser content seen by an event participant at various steps in the working illustrated in FIG. 2.

### DETAILED DESCRIPTION OF THE PREFERRED EMBODIMENTS

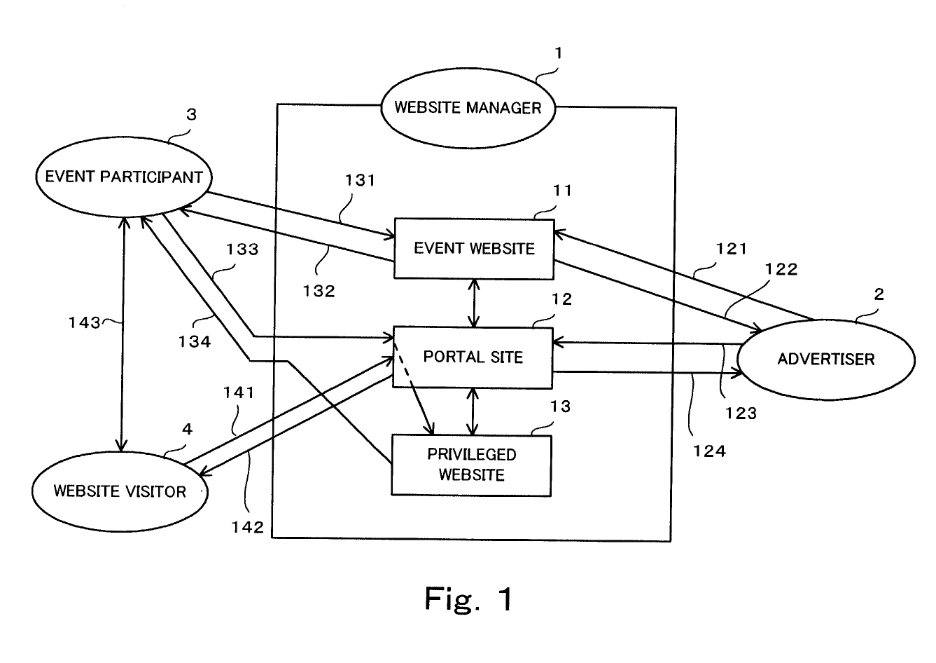

An embodiment of the present invention will now be described with reference to the drawings. FIG. 1 summarizes the configuration of an embodiment of the system of the present invention and aids an understanding of how this system works. It is assumed that event participant 3 and Website visitor 4 are mutually connected to Website manager 1 by a network such as the Internet.

Website manager 1 receives advertisement information and advertising fees from advertiser 2 who is an information provider such as a value-added carrier or an advertising agency (Steps 121 and 123), and in exchange discloses information relating to participants in an event (Steps 122 and 124). This information will be described below. It may be noted that although in FIG. 1 the event in question is shown as Website 11 on the Internet, an event can also be a concert, an exhibition of products or goods, a marketing seminar, etc.

Website manager 1 sends (Step 132), to event participant 3, a reward for participating in the event (Step 131) and the right to access a privileged Website (i.e., the privileged access right). Website manager 1 also operates portal site 12 on the Internet and privileged Website 13 that is linked to this portal site 12. Portal site 12 has a control function such that only a visitor who has a privileged access right can browse privileged Website 13.

When event participant 3 exercises a privileged access right to access privileged Website 13 (Step 133), a reward is sent to the event participant (Step 134), and Website manager 1 adds to a history that logs such exercises of privileged access right by event participant 3. As previously mentioned, Website manager 1 provides advertiser 2 with this accumulated history information and with information relating to the event participant (Steps 122 and 124).

Website visitor 4 is an ordinary user and can freely access portal site 12 (Step 141) and obtain information relating to an event (Step 142). After obtaining this event information, a user who is interested in the event in question can become an event participant 3 (Step 143).

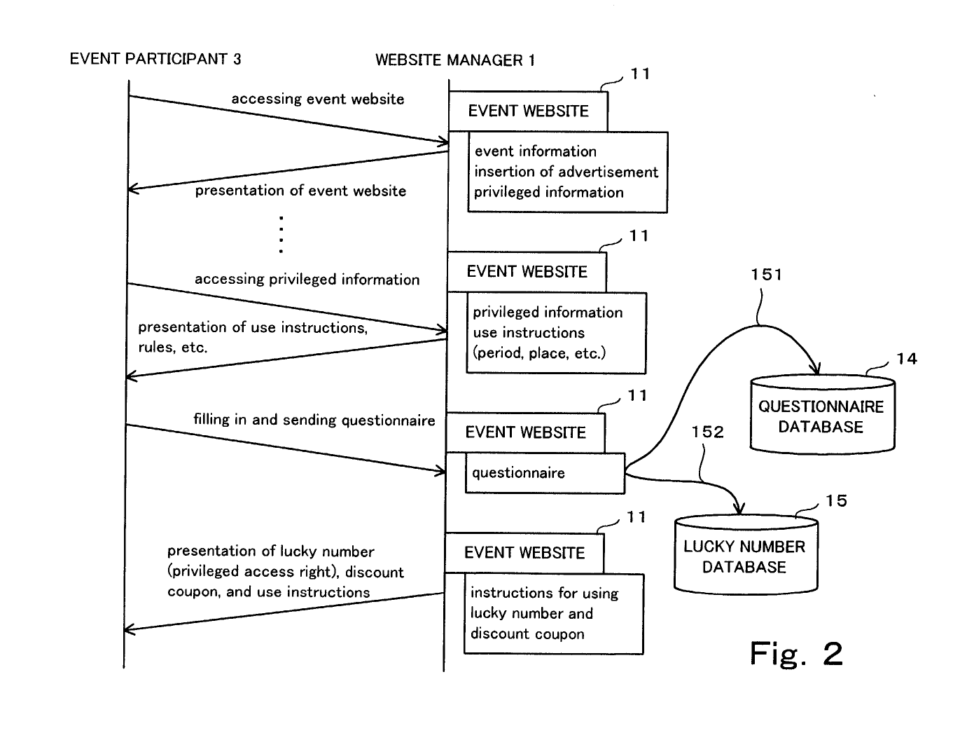

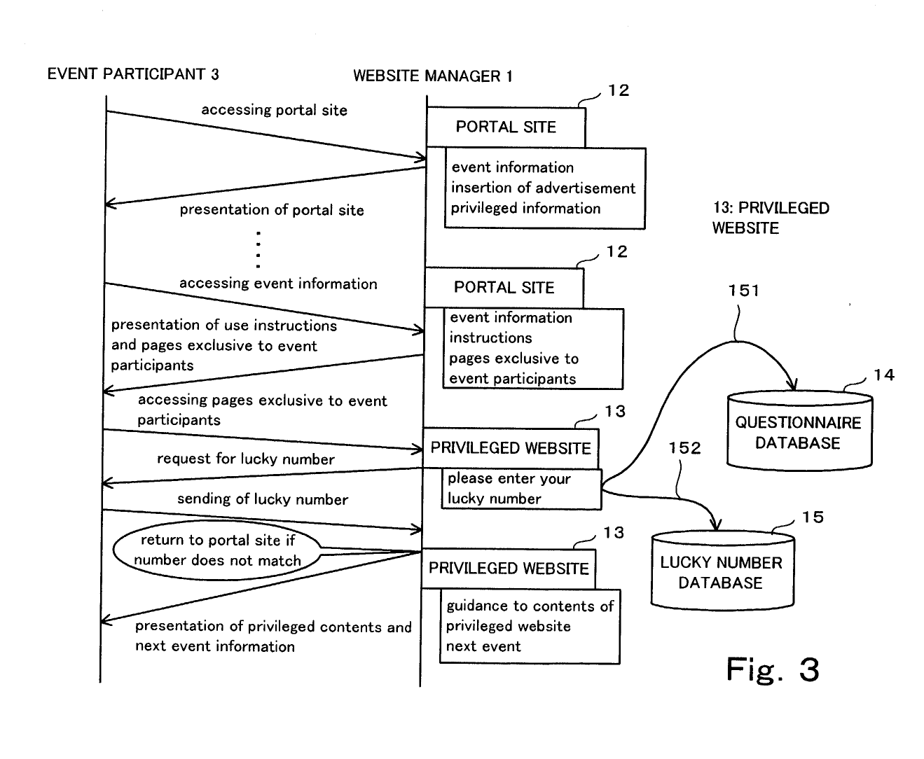

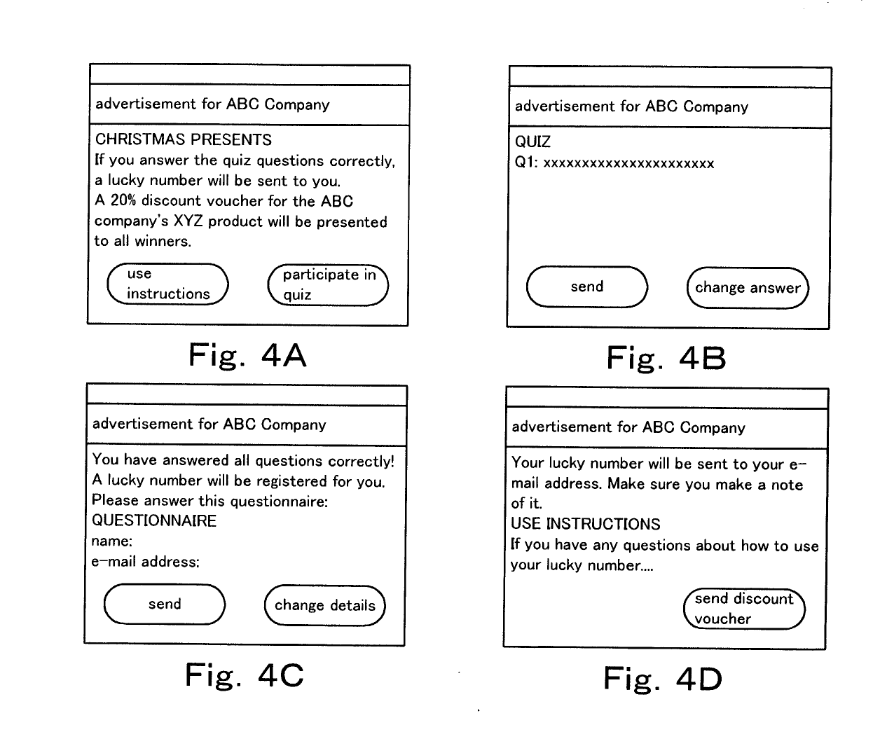

A more detailed description of the working of an embodiment of this invention will now be given with reference to FIGS. 2 and 3, and to FIGS. 4A to 4D. FIG. 2 and FIG. 3 illustrate an embodiment in which the event is held on the Internet, participant information is acquired by questionnaire, and a privileged access right takes the form of a lucky number. FIG. 2 shows the flow up to the event participant receiving a lucky number from the event Website, this lucky number being a privileged access right. FIG. 3 shows the flow up to the event participant exercising the privileged access right.

Referring to FIG. 2, participant 3, having received some form of appropriate guidance and successfully accessed the event, browses information relating to the event, such as that shown in FIG. 4A. An advertisement or the like from an advertiser is inserted along with the event information. In this embodiment, the name of the event is “Christmas Presents”, and if the participant answers a quiz correctly, he receives a lucky number. As a reward, the participant can get a voucher entitling him to a discount on the advertised product, etc. In this embodiment, acquiring a lucky number constitutes obtaining a privileged access right.

As indicated in FIG. 4B, quiz questions are presented one by one, and if these questions are answered correctly, information such as that shown in FIG. 4C is provided. The quiz in this embodiment constitutes the condition for determining whether a privileged access right is permitted (hereinafter, this will be called the “permission condition”), and it is therefore assumed that its degree of difficulty can be set appropriately.

In this embodiment, if event participant 3 replies to the questionnaire in order to specify the recipient of the lucky number, Website manager 1 registers the participant in questionnaire database 14 shown in FIG. 2 (Step 151) and assigns a lucky number from lucky number database 15 (Step 152). The answers to the questionnaire are stored in questionnaire database 14.

Once this storing is completed, the lucky number and information regarding the reward are sent to event participant 3. Instructions on using the lucky number are included. FIG. 4D shows the appearance of the screen when a lucky number is sent to a participant via e-mail.

Referring next to FIG. 3, when event participant 3 who has acquired a lucky number accesses portal site 12 where the event is being held, he sends the lucky number that was previously acquired, so that he can browse pages exclusive to privileged Website 13 on portal site 12. Website manager 1 looks up this lucky number in lucky number database 15 and at the same time registers, in questionnaire database 14, the fact that the participant has accessed a privileged Website.

In the case of an ordinary Website visitor 4 who has not received a lucky number, an error indication is displayed when lucky number database 15 is looked up, and the display returns to the original portal site 12 screen. On the other hand, event participant 3 can browse the privileged contents and the next event at privileged Website 13, with Website manager 1 providing the privileged contents. Website manager 1 reconfigures the information relating to accesses to privileged Website 13 and the questionnaire information, and provides this information to advertiser 2 in exchange for the advertising fee.

This embodiment presupposed that user information held by Website manager 1 is supplied to advertiser 2. However, the invention is also applicable, for example, to the manufacturer of the product that is being advertised, and to the telecommunications carrier that the Website manager is utilizing. In this case, the user information held by Website manager 1 can be put to use in the analysis of the market trends seen in the choice of products or telecommunication services made by a particular user group.

It may be noted that an increase in the number of event participants is even more likely if a valuable certificate, for example, a gift certificate or a points token, is issued as a reward that is only valid at the portal site in question. Moreover, an event does not have to take place on the Internet, and instead can be an event such as a concert, an exhibition of products or goods, a marketing seminar, etc. In the case of such events, it is feasible to utilize the privileged access right as an identification number (e.g., a time limited membership number) capable of specifying a participant.

As has been described above, according to the present invention, as a result of participating in an event held in a particular time period and a particular region, a user receives a privileged access right, this being issued by the Website manager who has organized the event. An event participant who has received this privileged access right can, by accessing a privileged Website that is provided by the Website manager, browse information on the privileged Website as well. This invention therefore has the following benefits: when the event participant acquires a privileged access right, he can also receive a reward such as a discount linked to a product; and the Website manager can, in exchange for an advertising fee, provide an advertiser with user information, along with information relating to accesses made to the privileged Website.

Holding an event enables the Website manager to acquire user information relating to event participants and to increase the number of times a site is accessed. Increasing the number of accesses means that the Website manager achieves greater publicity, via advertisements and the like. Moreover, by publishing, on a portal site, information relating to the holding of an event, the Website manager can achieve an increase in the number of secondary event participants. The advertiser can purchase market survey data such as what sort of customer group have displayed an interest during what time period in a particular product, and on this basis can create more effective advertising and publicity.

Furthermore, because a privileged access right is the principal means whereby a Website manager controls access to a privileged Website, the Website manager can regulate that access so as to achieve results that match the requirements of the advertiser, by for example adjusting the time period over which the privileged access right is valid, the number of times it can be issued, and the degree of difficulty involved in acquiring the privileged access right. Because information relating to participants is disclosed only to advertisers who have entered into a contract with the Website manager, inadvertent leaking of information is avoided. Advertising effectiveness can be increased by making event information and advertisements available on the portal site to ordinary users who have not participated in the event.

What is claimed is:

1. An event information provision method comprising: a step wherein a user participates in an event organized by an event manager; a privileged access right acquisition step wherein the aforementioned user, by participating in this event, acquires a preestablished privileged access right; a privileged Website information provision step wherein, in response to access by the aforementioned user who has exercised this privileged access right, said user is supplied with information exclusive to the privileged Website, said information being provided by the aforementioned event manager; and a step of registering information relating to the aforementioned user.

2. The event information provision method of claim 1, further comprising: a step of providing advertisement information for an event, said advertisement information being provided by an advertiser; and a step of providing the aforementioned advertiser with information relating to the aforementioned user, in exchange for an advertising fee in respect of this advertisement.

3. The event information provision method of claim 1, further comprising, in the aforementioned privileged access right acquisition step, setting a condition that the aforementioned user has to satisfy in order to acquire the privileged access right, this condition having some degree of difficulty, and granting the privileged access right to the aforementioned user if the user satisfies this condition.

4. The event information provision method of claim 1, further comprising, in the aforementioned privileged Website information provision step, checking, in response to access by the aforementioned user, whether or not that user has obtained the privileged access right, and providing the privileged Website information only if the user has obtained the right.

5. The event information provision method of claim 1, wherein the aforementioned event manager and the aforementioned user are connected via a network, and information relating to the aforementioned event and information relating to the privileged Website are registered at a portal site.

6. An event information provision system comprising: privileged access right granting means for granting a preestablished privileged access right to a user who participates in an event organized by an event manager; privileged Website information provision means which, in response to access by the aforementioned user who has exercised this privileged access right, supplies that user with information exclusive to the privileged Website, said information being provided by the aforementioned event manager; and registration means for registering information relating to the aforementioned user.

7. The event information provision system of claim 6, further comprising means for providing the aforementioned advertiser with information relating to the aforementioned user, in exchange for an advertising fee in respect of an advertisement for the aforementioned event, said advertisement having been provided by the advertiser.

8. The event information provision system of claim 6, wherein the aforementioned privileged access right granting means sets a condition that the aforementioned user has to satisfy in order to acquire the privileged access right, this condition having some degree of difficulty, and grants the privileged access right to the aforementioned user if the user satisfies this condition.

9. The event information provision system of claim 6, wherein the aforementioned privileged Website information provision means checks, in response to access by the aforementioned user, whether or not that user has obtained the privileged access right, and provides the privileged Website information only if the user has obtained the right.

10. The event information provision system of claim 6, wherein the aforementioned event manager and the aforementioned user are connected via a network, and information relating to the aforementioned event and information relating to the privileged Website are registered at a portal site.
